(19) United States
(12) Patent Application Publication
(10) Pub. No.: US 2025/0230002 A1
(43) Pub. Date: Jul. 17, 2025

(54) REAL-TIME CONCRETE PRODUCTION PERFORMANCE MONITORING SYSTEM WITH ENHANCED PROCESS CONTROL AND REPORTING

(71) Applicant: DigitalPlant LLC, Bigelow, AR (US)

(72) Inventors: Garfield LIDDON, Bigelow, AR (US); Samuel R. MAXWELL, Westerville, OH (US); Robert M. McCAIN, Winston-Salem, NC (US); Randall E. WILLAMAN, Mount Gilead, OH (US); Jack R. DELPERDANG, Sevierville, TN (US)

(73) Assignee: DigitalPlant LLC, Bigelow, AR (US)

(21) Appl. No.: 19/025,070

(22) Filed: Jan. 16, 2025

Related U.S. Application Data
(60) Provisional application No. 63/621,264, filed on Jan. 16, 2024.
(60) Provisional application No. 63/697,215, filed on Sep. 20, 2024.

(51) Int. Cl. B65G 69/00; B65G 67/04

(52) U.S. Cl. CPC B65G 69/00; B65G 67/04

(57) ABSTRACT

Disclosed herein are system, method, and computer program product embodiments for real-time concrete production performance monitoring with enhanced process control and reporting. For example, a hopper coupled to a truck may be detected to be under a loading point of a concrete plant based on one or more signals provided by one or more sensors. An identifier associated with the truck is obtained. A determination is made that the identifier is associated with a ticket that indicates that the truck is scheduled to be loaded from the truck loading point of a concrete plant. A determination is made that the truck is ready to be loaded based on (i) detecting that the hopper is under the truck loading point (ii) the truck drum is rotating at the proper speed and direction and (iii) determining that the identifier is associated with the ticket.

### CROSS-REFERENCE TO RELATED APPLICATION(S)

This application claims the benefit of U.S. Provisional Application Ser. No. 63/621,264, filed Jan. 16, 2024 and entitled REAL-TIME CONCRETE PRODUCTION PERFORMANCE MONITORING SYSTEM WITH ENHANCED PROCESS CONTROL AND REPORTING, and U.S. Provisional Application Ser. No. 63/697,215, filed Sep. 20, 2024 and entitled REAL-TIME CONCRETE PRODUCTION PERFORMANCE MONITORING SYSTEM WITH ENHANCED PROCESS CONTROL AND REPORTING, which are incorporated by reference herein in their entireties.

### BACKGROUND

Concrete production is a complex process that typically involves a dispatch office that takes orders and dispatches concrete trucks to carry loads of concrete to service those orders, a concrete plant that weighs up the material constituents (liquids will typically be metered) and discharges them into the concrete trucks, and the concrete trucks themselves, which transport the loads of concrete to a jobsite and pour them out for use in a job. To ensure that the concrete production process is being carried out optimally—or even efficiently—it is essential to be able to extract and analyze data about all the various steps that must be carried out to execute the process, from the issuance of a dispatch ticket by the dispatcher to the truck leaving the yard. However, for a variety of reasons, no systems currently exist that can perform such comprehensive end-to-end performance tracking.

### BRIEF DESCRIPTION OF THE DRAWINGS

The accompanying drawings are incorporated herein and form a part of the specification.

FIG. 1 depicts an example concrete production environment.

FIG. 2 depicts a flowchart of an example concrete production workflow.

FIG. 3 depicts an example concrete production environment that includes a performance monitoring system in accordance with an embodiment.

FIG. 4 is a block diagram of a system for determining that a truck is under a truck loading point of a material plant, according to some embodiments.

FIG. 5 is a flowchart of an example method for determining that a truck is under a truck loading point of a material plant, according to some embodiments.

FIGS. 6A and 6B are block diagrams of systems for ensuring that the proper material is loaded in a proper bin, according to some embodiments.

FIG. 7 is a block diagram of an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are a system, apparatus, device, method and/or computer program product embodiments, and/or combinations and sub-combinations thereof for real-time concrete production performance monitoring with enhanced process control and reporting. For example, a hopper coupled to a truck may be detected to be under a loading point of a material (e.g., concrete) plant based on one or more signals provided by one or more sensors. An identifier associated with the truck is obtained. A determination is made that the identifier is associated with a ticket that indicates that the truck is scheduled for being loaded at the truck loading point. A determination is made that the truck is ready for loading based on (i) detecting that the hopper is under the gate of the loading point (ii) determining the speed and rotation of the truck mixer drum and (iii) determining that the identifier is associated with the ticket.

### A. Example Concrete Production Environment

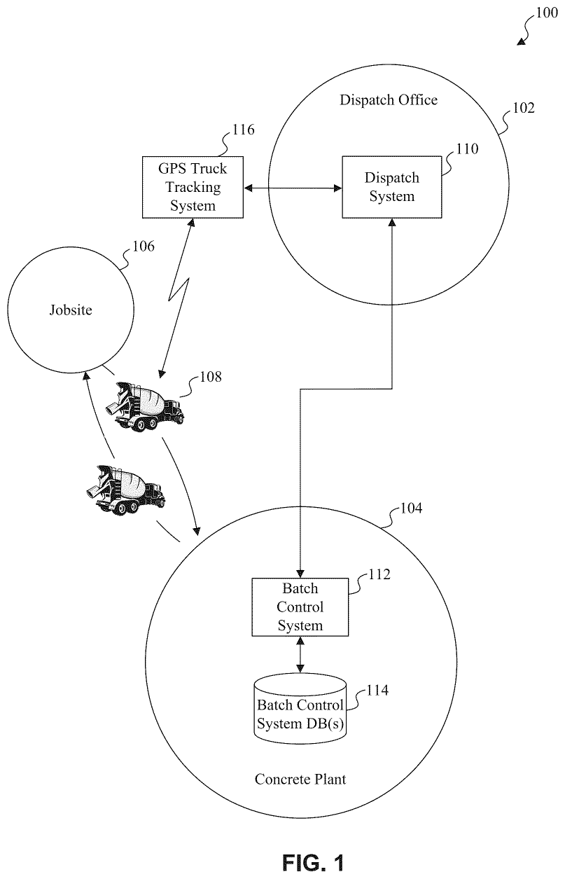

FIG. 1 depicts an example concrete production environment 100. As shown in FIG. 1, example concrete production environment 100 includes at least a dispatch office 102, a concrete plant 104 and a jobsite 106. Each of these facilities will now be described.

Dispatch Office. Concrete producers may take orders and dispatch concrete trucks in a variety of ways. Local dispatch refers to a scenario in which a concrete plant controls its own orders and load scheduling. Central dispatch refers to a scenario in which a central dispatch office manages orders and load scheduling for multiple different concrete plants. Additionally, some concrete producers maintain a number of regional dispatch offices, each of which manages orders and load scheduling for one or more concrete plants within a respective geographical region.

A dispatch office may have order takers and dispatchers (or shippers). An order taker may be responsible for taking (e.g., receiving and recording) orders while a dispatcher may be responsible for dispatching trucks to carry loads of concrete as part of servicing various orders. Thus, the dispatcher may determine which customer receives the next load of concrete from a concrete plant.

In example environment 100 of FIG. 1, dispatch office 102 may represent, for example, a central dispatch office or a regional dispatch office.

Concrete Plant. A concrete plant is a facility used for making concrete from the raw material that composes it: fine aggregate, coarse aggregate, cementitious materials, water and liquid admixtures that affect the performance of the concrete. The concrete may also include other components such as filler, reinforcing fibers, color or additives.

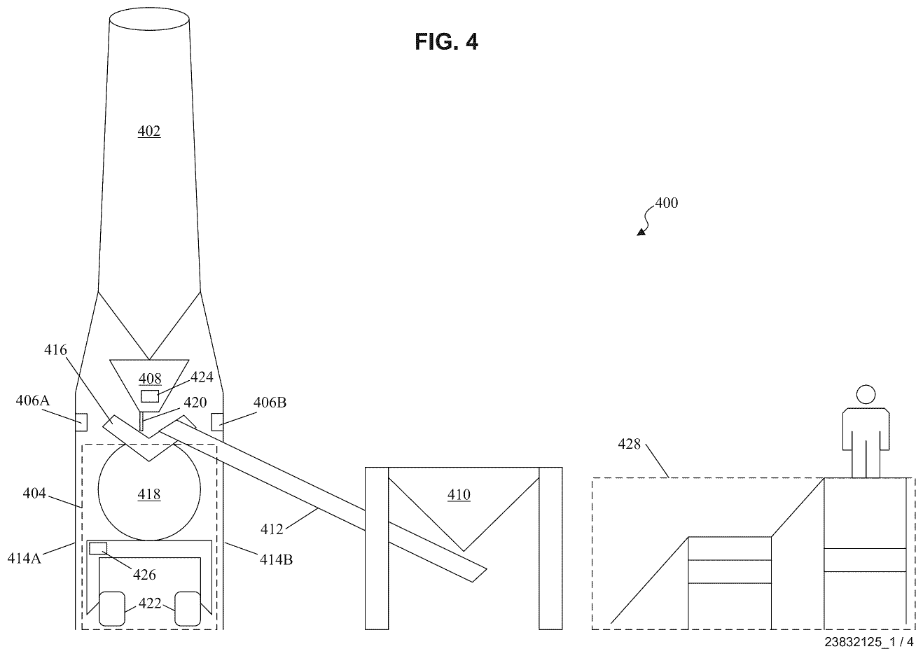

A dry mix concrete plant (also referred to as a ready mix plant or a transit mix plant) weighs sand, coarse aggregate and cement in weigh batchers via suspended load cells. The load cells are analog devices that are interfaced to a batch control system. The ingredients are then discharged into a chute, which discharges into a truck hopper (e.g., truck hopper 416, as will be described below with reference to FIG. 4) and, thereafter, into the mixer drum (e.g., mixer drum 418, as will be described below with reference to FIG. 4) of mixer truck 108. Water may be weighed or volumetrically metered and concurrently discharged through the same charging chute into the mixer truck 108. These ingredients are then mixed at high speed for approximately 70 revolutions in the truck. The mixer truck continues to agitate the concrete during transportation to the jobsite.

A wet mix concrete plant 104 (also referred to as a central mix plant) combines some or all of the above ingredients (including water) at a central location into a concrete mixer. That is to say, the concrete is mixed at a single point, and then simply agitated on the way to the jobsite using dump trucks or ready mix trucks. Wet mix plants differ from dry mix plants in that wet mix plants contain a central mixer, which can offer a more consistent mixture in a shorter time. Dry mix plants typically see more break strength standard deviation and variation from load to load because of inconsistencies in mix times, truck blade and drum conditions, traffic conditions, etc. Certain plants combine both dry and wet characteristics to meet the demands of the concrete specifications.

Concrete plants 104 may also be fixed (or stationary) or mobile (or portable). A fixed concrete plant 104 is one that is fixed on a foundation and is typically used for large-scale concrete production that requires high-quality concrete. A mobile concrete plant 104 is designed such that it may be towed to a particular location (e.g., at or near a jobsite 106), assembled for use, then later disassembled and towed to another location.

Concrete plant 104 shown in FIG. 1 may be a wet mix plant or a dry mix plant. Concrete plant 104 shown in FIG. 1 may also be a fixed plant or a mobile plant.

Although FIG. 1 only shows a single concrete plant 104, it should be understood that example concrete production environment 100 of FIG. 1 may include multiple concrete plants and multiple dispatch offices 102 may take orders and dispatch concrete trucks for multiple concrete plants.

Jobsite. The jobsite is the location to which concrete is delivered via one or more concrete trucks 108 and where the concrete is poured from the trucks. Concrete may be used to construct buildings, bridges, roads, dams, parking structures, walls, sidewalks, as well as other structures.

Although only a single jobsite 106 is shown in FIG. 1, it should be understood that example concrete production environment 100 may include multiple jobsites 106 and that concrete trucks 108 may be dispatched from one or more concrete plants 104 to service each of the jobsites 106.

In addition to dispatch office 102, concrete plant 104 and jobsite 106, example concrete production environment 100 of FIG. 1 includes several automated components. These include a batch control system 112, a dispatch system 110, and a GPS truck tracking system 116. Each of these components will now be described.

Batch Control System. Batch control system 112 is used to control concrete plant 104, during the batching process or when idle. Batch control system 112 enables an operator to weigh up and discharge the material into truck 108 in an automated or semi-automated fashion. In some aspects, batch control system 112 may comprise a personal computer (PC) or other general processing unit upon which batch control software is executed (a “batch PC”), one or more associated monitors, a programmable logic controller (PLC) or a real time controller (RTC), a manual station (which can be optional), and a junction box. Other variations could include a number of distinct remote input/output (RIO) devices to control the plant. The batch PC may communicate with the plant controls via the PLC, RTC or RIO. The PLC, RTC or RIO may control the opening and closing of various gates in performing the batching process. The PLC or RTC may also read scales, moisture probes, sensors and meter counts. The PLC or RTC may communicate with the manual station via a serial connection. In some configurations, the PLC or RTC may be virtualized and reside on a PC along with an operating system (OS) and the batch control software. The manual station may hold the scale calibrations and the display settings. The manual station may connect to the junction box via two 48 conductor cables, twisted pair, or fiber optic cables and/or via electromagnetic waves. Some manual stations may switch 5-24 VDC to control a 110 AC that feeds the concrete plant. Other manual stations may utilize 120 volt switches. Scale and probe signals may be wired directly to the manual station bypassing the junction box. The plant control cable may be terminated in the junction box, electrically connecting the plant devices to the manual station hardware.

Batch control system 112 may utilize a database engine (e.g. an SQL database engine) to store information in one or more batch control system databases 114. Such information may include but is not limited to information concerning materials, mix designs, plant devices and other concrete production related information.

In some aspects, batch control system 112 may be implemented using COMMANDbatch® software and hardware, manufactured and sold by Command Alkon Incorporated.

Dispatch System. Dispatch system 110 is an information system that generates a delivery schedule based on how the orders are scheduled. This typically includes multiple concrete plants 104 and multiple jobs sites 106. Dispatch system 110 may comprise software executing locally on a PC at dispatch office 102. Alternatively, dispatch system 110 may comprise an application that executes in the cloud with an associated front-end/user interface (UI) executing on a computer at dispatch office 102. Dispatch system 110 may be used to schedule, input and track orders, track the status of concrete trucks used to service orders, and to assign a particular concrete truck 108 to a particular order to help fulfill the order.

The assignment of a particular concrete truck 108 to a particular order results in the generation of an electronic ticket which is then transmitted by dispatch system 110 to batch control system 112. Dispatch system 110 may be communicatively connected to batch control system 112 via one or more networks (e.g., the Internet) and transmit tickets thereto using a standard protocol, such as the Universal Link (ULINK) protocol, or other suitable application programming interface (API).

GPS Truck Tracking System. GPS truck tracking system 116 is configured to leverage GPS technology to track concrete trucks 108 being dispatched by dispatch system 110 and to continuously update dispatch system 110 in near real-time with status changes for each concrete truck.

In some implementations, a concrete truck 108 may be assigned one of eight different statuses at any given time: “ticketed”, “loaded”, “to job”, “on job”, “start pour”, “end pour”, “returning”, and “at plant”. “Ticketed” means that the ticket has be sent from dispatch system 110 to batch control system 112 but that the concrete truck has not yet been loaded. “Loaded” means that the concrete truck has been completely loaded but has not yet left concrete plant 104. “To job” means that the concrete truck has left concrete plant 104 but has not yet arrived at jobsite 106. “On job” means that the concrete truck 108 has arrived at jobsite 106 but hasn't started pouring concrete. “Start pour” means that the concrete truck has started pouring concrete at jobsite 106. “End pour” means that the concrete truck 108 has finished pouring concrete at jobsite 106 but has not yet departed jobsite 106. “Returning” means that the concrete truck has left jobsite 106 to return to concrete plant 104 but has not yet arrived at concrete plant 104. “At plant” means that the concrete truck has returned to concrete plant 104.

A concrete truck 108 may include a GPS device that is in communication with GPS truck tracking system 116 (e.g., via a cellular communication network or other suitable communication link). The GPS device may be capable of reporting a current GPS location of the concrete truck 108 at any given time. The GPS device, or GPS truck tracking system 116, may compare such GPS location data with geofence coordinates associated with concrete plant 104 to determine whether the concrete truck 108 is at concrete plant 104 or not. Likewise, the GPS device, or GPS truck tracking system 116, may compare such GPS location data with geofence coordinates of jobsite 106 to determine whether the concrete truck 108 is at jobsite 106 or not. The GPS device in the concrete truck 108 may also be connected to a magnetic sensor or some other type of sensor on the concrete truck 108 that generates a signal when a mixing drum of the concrete truck 108 begins rotating in a reverse direction, which is indicative of the beginning of concrete pouring. Likewise, information generated by such a magnetic sensor can indicate when such reverse rotation has ceased, indicating that concrete pouring has ended. Information obtained in this manner may be relayed from the GPS device to GPS truck tracking system 116 and GPS truck tracking system 116 may use such information to update the status of the concrete truck 108 within dispatch system 110.

### B. Example Concrete Production Workflow

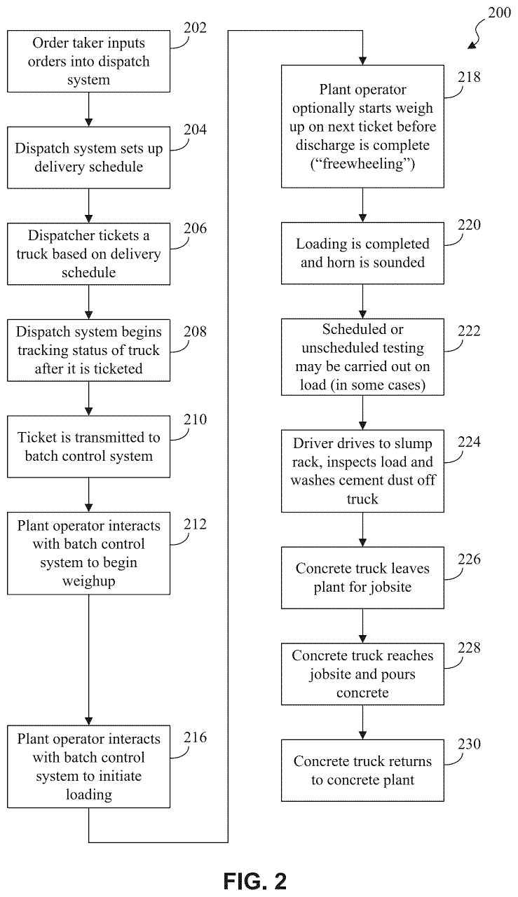

To facilitate further understanding of the concrete production process, an example concrete production workflow 200 is shown in FIG. 2. Workflow 200 will now be described with continued reference to example concrete production environment 100 of FIG. 1. However, workflow 200 is described herein by way of example only. Persons skilled in the relevant art(s) will readily appreciate that a concrete production process may include additional steps, fewer steps, and/or different steps than those described herein in reference to workflow 200.

Workflow 200 begins at 202, with an order taker inputting orders into dispatch system 110. Each order may include information such as company or customer name, project name, project location, contact person, project type (e.g., is it a public works contract), schedule (e.g., time customer wants concrete on site and spacing), slump (consistency of the concrete), strength (e.g., measured by the designed compressive strength in pounds per square inch (PSI) of a hardened cylinder of concrete), mix design (e.g., mix numbers quoted for a project), additional items (e.g., value-added products like fibers, non-chloride accelerators or retarders that will aid in placement or finishing or color to enhance the aesthetic characteristics of the concrete), placement (e.g., whether concrete will be poured directly from the chute of the truck, with a wheelbarrow, or pumped into place with a concrete pump), quantity of concrete (e.g., number of yards), and an identification of a concrete washout area.

At 204, based on the orders accumulated for a given day, dispatch system 110 sets up a delivery schedule based on when the concrete trucks 108 need to be at the jobsites. Dispatch system 110 may utilize plant-level default times (e.g., a default ticket time, a default loading time, a default slump rack time, etc.) to determine recommended ticketing times for the dispatcher. For example, dispatch system 110 may utilize such plant-level default times to work backwards from a desired delivery time to a recommended ticketing time for a particular load.

At 206, the dispatcher electronically tickets a concrete truck based on the delivery schedule generated in 204. Ticketing a concrete truck may entail assigning a particular concrete truck to a particular order. In some aspects, the ticketed status may be triggered by the dispatcher interacting with a graphical UI (GUI) of dispatch system 110 to drag a GUI element representing a particular concrete truck 108 onto another GUI element representing a particular order, although this is only an example. Dispatch system 110 may identify for the dispatcher the concrete truck 108 that has been in the yard the longest as well as the order that that requires the next load, and the dispatcher may use such information to associate the concrete truck with the load. However, it is noted that the dispatcher may assign a concrete truck 108 to an order that isn't next in line for a load (e.g., to honor a particular customer relationship or for some other reason). The ticket generated by dispatch system 110 in 206 is typically an electronic ticket. As noted below, this electronic ticket is transmitted to batch control system 112, which typically prints a corresponding physical ticket.

The dispatcher may utilize a load customization feature of dispatch system 110 to make changes to a given load. For example, the dispatcher may add equipment (e.g., a pair of gloves, some rebar) to a particular load. As another example, the dispatcher may specify a 4″ slump may be used for the first three trucks associated with an order and then a 5″ slump may be used for the remaining trucks. As another example, the dispatcher could change the admixtures associated with different loads, such as by starting out with a 2% calcium admixture and then changing that after the fifth load. The dispatcher may also utilize the load customization feature to add a testing requirements or additional items such as fiber that requires additional time for a particular load which must be carried out at concrete plant 104.

At 208, dispatch system 110 begins tracking the status of the concrete truck 108 that was ticketed in 206, leveraging information provided by GPS truck tracking system 116. As discussed above, in some implementations, a concrete truck 108 may be assigned one of eight different statuses at any given time: “ticketed”, “loaded”, “to job”, “on job”, “start pour”, “end pour”, “returning”, and “at plant”.

At 210, the ticket is transmitted from dispatch system 110 to batch control system 112. After the ticket has been received by batch control system 112, the plant operator at concrete plant 104 can determine the mix, the truck, the load size, the job address, and the like. In some cases, the plant operator may make minor changes to the ticket such as a water adjustment or an adjustment to air.

At 212, the plant operator interacts with batch control system 112 to begin the weighing of certain raw materials, such as cement, fine aggregates, and coarse aggregates, that will be part of the homogeneous concrete mix. This process may also be referred to as “weigh up.” Once the load starts to weigh up, the gates to the overhead aggregate bins open and drop material into the aggregate scale. Simultaneously, the cement gates open and the cement drops into the cement weight batcher. Weigh up also includes the weighing or volumetric metering of the water and liquid admixtures that will be discharged into the mixer drum. Admixtures can be metered into a bottle and then discharged into the truck (or central mixer) or they can be metered directly into the truck drum 418. Most typically, admixtures are discharged with the headwater, but they can also be discharged with the trail water.

In some implementations, in response to the beginning of weigh up, batch control system 112 prints a header of the ticket. If the dispatcher wants batch weights to appear on the ticket, then those batch weights will be printed on the ticket either when weigh up ends or when discharge ends. Typically, the batch control system 112 prints the physical ticket and plant operator provides it to the driver. The printed ticket is typically a 3- or 4-part form or may be an electronic ticket. One copy of the ticket may be brought by the driver to the job foreman for signature thereby; another copy of the ticket may be retained by concrete plant 104; and a further copy of the ticket may be provided to an administrative office for billing purposes. Electronically delivered tickets use e-signatures or similar mechanism.

At 216, the plant operator interacts with batch control system 112 to initiate discharge or loading of the materials into the mixer drum 418 of the concrete truck 108. In a dry mix plant, typically 80% to 90% of the water goes into the truck mixer drum before the material goes into the truck mixer on a dry batch plant. This is referred to as headwater. Once the material is discharged into a mixer truck then the batch control system 112 discharges the tail water which completes the loading process.

As noted at 218, the plant operator may optionally start weigh up on the next ticket before discharge is complete with respect to the current ticket. This practice is sometimes referred to as “freewheeling” or “fast batch” and is typically considered a desirable practice as it can improve the operational efficiency of concrete plant 104.

At 220, once the loading of the concrete truck is completed and a horn is sounded to notify the driver of the concrete truck 108 of the same.

After the concrete truck 108 is loaded, the driver typically drives the truck to a slump rack and inspection platform to inspect the load and wash cement dust off the concrete truck 108 as shown at 224. However, in some scenarios, scheduled or unscheduled testing must first be carried out on the load as shown at 222. Typically, such testing involves air testing, slump testing, or air and slump testing.

After any scheduled or unscheduled testing is completed at 222 and the load is inspected at 224, the concrete truck 108 leaves concrete plant 104 for jobsite 106 at 226.

At 228, the concrete truck 108 reaches jobsite 106 and the concrete is poured.

At 230, after the concrete has been poured, the concrete truck 108 returns to concrete plant 104.

### C. Challenges

Currently, there is no production performance monitoring solution for the concrete industry. Consequently, dispatchers don't know exactly when a truck should leave the yard. Management also doesn't have any visibility into why there are delays in the production process. If a concrete plant 104 is having issues getting concrete out of the yard, then management doesn't know if the issue is associated with the dispatcher, the truck driver, loader operator, the concrete plant, or the plant operator.

By way of example, there may be different reasons for an unnecessary delay in starting the loading of a truck 108. These could include a problem with the plant 104, a problem with the plant operator (e.g., plant operator doesn't start the discharge as early as they could/should), a problem with the driver/concrete truck 108 (e.g., the truck is not under the plant when it needs to be), or a problem with the load operator (e.g., the concrete plant 104 ran out of material because the loader didn't fill the bin). Presently, a concrete producer has no way to determine the delay reason.

As another example, there may be different reasons that a plant operator fails to take advantage of a freewheeling opportunity by starting weigh up on a next ticket while completing discharge on a current ticket. This could be because there was delay by the dispatcher in transmitting the next ticket such that the next ticket is not on the stack during discharge of the load associated with the current ticket. This could also be because there was delay by the plant operator in initiating weigh up for the next ticket. Presently, producer has no way to determine what is causing the delays.

As noted in the Background Section above, to ensure that the production process is being carried out optimally—or even efficiently—it is essential to be able to extract and analyze data about all the various steps that must be carried out to execute the process, from the issuance of a dispatch ticket by the dispatcher to the truck leaving the yard. However, for a variety of reasons, no systems exist that can perform such comprehensive end-to-end performance tracking.

First, none of the automated systems currently involved in the concrete production process (dispatch system 110, batch control system 112, and GPS truck tracking system 116) can provide a complete view of the end-to-end process. Dispatch system 110 is an information system that is designed to generate a schedule for dispatching trucks 108 to deliver concrete from one or more concrete plants 104 to one or more jobsites 106. Consequently, dispatch system 110 typically tracks pending orders, the statuses of the concrete trucks 108, and whether a ticket has been sent to batch control system 112. Batch control system 112 is an industrial control system for managing the process of batching material. Consequently, the operation of batch control system 112 is mostly limited to controlling the processes of weighing up material (and liquids) and discharging the load into a truck. GPS truck tracking system 116 is primarily focused on tracking the statuses of the trucks.

At present, there exists no means for obtaining data from each of the systems and combining such data to generate important insights about the performance of the concrete production process. Because these disparate systems were independently designed from the ground up to perform very different functions, each system maintains its own separate database(s) and very little data is shared between the systems. Furthermore, integrating such systems is a non-trivial challenge at least in part because information technology (IT) specialists who are likely to understand the workings of information systems such as dispatch system 110, but typically lack knowledge of how concrete plants (104) work and batch control systems 112 control them.

Furthermore, even if the challenge of extracting and synthesizing relevant concrete production performance data from all three systems could be surmounted, there would still blind spots in terms of tracking performance. For example and without limitation, none of the aforementioned systems is capable of determining when a concrete plant starts operating for the day or shuts down operation for the day, when a concrete truck should be under the concrete plant so that there are no delays in the batching process, when a freewheeling opportunity exists, how long the truck/driver spends at the testing area or slump rack (or inspection station), or when the concrete truck 108 should leave the yard.

### D. Real-Time Concrete Production Performance Monitoring System with Enhanced Process Control and Reporting

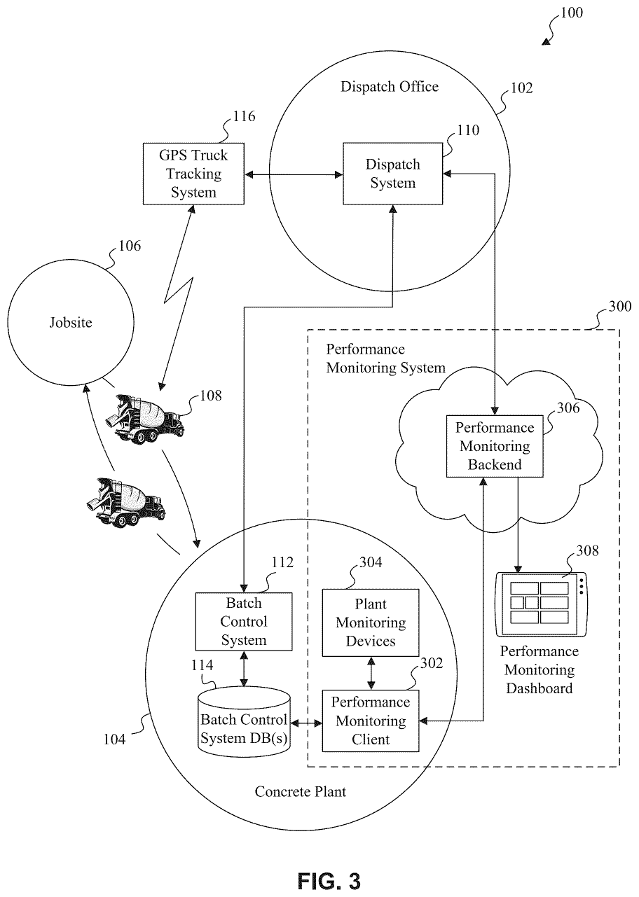

A real-time concrete production performance monitoring system 300 that allows for enhanced process control and reporting will now be described in reference to FIG. 3. As will be made apparent from this description, performance monitoring system 300 may address some or all of the challenges discussed in the preceding section. For example, performance monitoring system 300 may provide a performance monitoring dashboard 308 that enables a concrete producer to track the performance of their dispatcher, plant 104, plant operator, loader operator and driver throughout the concrete production process. Performance monitoring system 300 may gather information from batch control system 112 and/or batch control system database(s) 114 and certain plant monitoring devices 304. In some aspects, performance monitoring system 300 may also gather information from dispatch system 110 and/or GPS truck tracking system 116. Such information may be provided to a performance monitoring backend 306 (e.g., executing in the cloud or on one or more dedicated servers) and processed thereby to generate relevant performance data and statistics. Performance monitoring backend 306 may then display such performance data and statistics to the concrete producer (and/or other persons or entities) via performance monitoring dashboard 308.

In some embodiments, performance monitoring system 300 may track the concrete production process at least from the time that a ticket received by the batch control system 112 and the concrete plant 104 is available until the concrete truck is out of the yard. Performance monitoring system 300 may track the actual amount of time it takes to perform certain operations and compare such actual times against performance metrics in dashboard 308. Such performance metrics may be provided by the concrete producer as inputs to performance monitoring system 300 and stored thereby.

Concrete producers have more data than they have time to review. Performance monitoring system 300 can identify critical data that relates to specific duties and responsibilities that can be delivered to an employee anywhere, anyplace, and in “near real time”. Providing this data can allow an employee to better understand how they are performing against prescribed operational targets set for them by management. Providing such data can also allow management to react and resolve performance issues while they are happening in real-time. Performance monitoring system 300 can also improve employee decision making, changing bad operation and human behaviors.

As shown in FIG. 3, performance monitoring system 300 may operate within the context of example concrete production environment 100. Performance monitoring system may include the aforementioned performance monitoring backend 306 (e.g., executing in the cloud or on one or more dedicated servers) and performance monitoring dashboard 308 generated thereby, which may be presented on a display of any number of suitable computing devices (e.g., tablets, laptop computers, desktop PCs, smartphones, or the like).

As further shown in FIG. 3, performance monitoring system 300 may also include a performance monitoring client 302 and one or more plant monitoring devices 304. Plant monitoring devices 304 may be installed on, at, or around concrete plant 104 and each of plant monitoring devices 304 may be connected to performance monitoring client 302 via one or more wired and/or wireless communication links.

Performance monitoring client 302 comprises a program that pushes data from batch control system 112 and/or batch control system database(s) 114, dispatch system 110 and GPS system 116 to performance monitoring backend 306 (e.g., as .csv, json, etc. files), where such data is stored for subsequent processing (e.g., in a database in the cloud). Performance monitoring client 302 also comprises a program that collects data from plant monitoring devices 304 and pushes such data to performance monitoring backend 306, where such data is stored for subsequent processing. Performance monitoring client 302 may be installed and executed on one or more computing devices present at concrete plant 104. For example, performance monitoring client 302 may be installed on the same computing device(s) upon which batch control system 112 is installed and executed, or on a co-located computing device that is connected to the computing device(s) upon which batch control system 112 is installed and executed. Alternatively, performance monitoring client 302 may be executed on a computing device that is connected to the computing device(s) upon which batch control system 112 is installed and executed but remotely located with respect to concrete plant 104 (e.g. on a virtual machine in the cloud).

Performance monitoring client 302 may send near real-time information from batch control system 112 and/or batch control system database(s) 114 to performance monitoring backend 306, whereas other information may be polled in accordance with a particular time schedule. For example, performance monitoring client 302 may utilize a UDP link or TCP/IP link to batch control system 112 to listen for real-time events, such as when a ticket is sent, when weigh up has started, when weigh up has ended, when discharge has started, and when discharge has ended. An example of information that may be polled at a particular time interval may include inventory records maintained in batch control system database(s) 114. In some aspects, one or more computer programs are used to obtain the real-time data while one or more computer programs are used to poll the other data. In a further implementation, each of these programs may be executed on a different computing device.

Plant monitoring devices 304 may comprise one or more devices that may be used to collect information about events occurring at or around concrete plant 104. Such devices may include, for example and without limitation, various types of sensors and/or various types of Internet of Things (IoT) devices that incorporate sensing capabilities. The inclusion of these devices enable performance monitoring system 300 to obtain information about the concrete production process that could not otherwise be provided by dispatch system 110, batch control system 112 or GPS truck tracking system 116.

By way of example, plant monitoring devices 304 may include one or more plant/truck sensors. Such truck sensor(s) may be used, for example, to identify when a truck is under a truck loading point of concrete plant 104, when a truck is at a testing area of concrete plant 104, or when a truck is at a slump rack (or inspection station) of concrete plant 104.

A truck sensor may comprise, for example, a camera that is mounted on or around concrete plant 104. The camera may be used, for example, to determine whether the rear wheel of a concrete truck is in a proper position for loading.

Additional techniques may be utilized to ensure that the correct truck (as opposed to just any truck) is at the loading point, the testing area, or the slump rack and inspection station. For example, each truck may be labelled with a unique code (or other perceptible unique identifier), including, but not limited to a quick response (QR) code, a barcode, or data matrix code, thereby enabling a camera to detect both the location of the truck and its associated identity. As another example, Bluetooth communication may be used to convey identifying information from the truck (e.g., from a Bluetooth key chain) to a wireless (e.g., Bluetooth, ultra-wide band (UWB), or the like) receiver installed at concrete plant 104 when the truck is within range of the receiver. Radio frequency identification (RFID) or near-field communication (NFC) tags and readers may also be used.

In some aspects, such as when concrete plant 104 occupies a relatively large area, GPS data reported by GPS devices installed on the concrete trucks 108 may be used, alone or in combination with other data, to determine a location of the truck 108 within concrete plant 104 (e.g., below the plant, at testing area, or at slump rack or inspection station).

In a scenario in which concrete plant 104 is a wet mix plant, plant monitoring devices 304 may also include a magnetic sensor, camera, or other electronic sensor that is installed proximate to a central mixer. Such magnetic sensor may be used to determine a number of revolutions made by the central mixer for each load of concrete batched by the plant 104.

Such information may also be used by performance monitoring system 300 to determine how long the material for each load was in the drum of the central mixer.

Plant monitoring devices 304 may further include an air gauge sensor that may be used to determine whether an air compressor that is used to control various gates in concrete plant 104 (e.g., gates to overhead aggregate bins, a cement feeder gate) is operating. As will be discussed below, detected changes in the operating state of the air compressor may be used to infer when concrete plant 104 starts operating for the day and shuts down at the end of the day. Still other methods may be used to determine when concrete plant 104 starts operating for the day and shuts down at the end of the day. For example, the times when batch control system 112 is started up and shut down may be logged, and these logged times may be used to infer the times when concrete plant 104 starts and stops operating, respectively. Images collected by a camera installed on, at, or around concrete plant 104 may also be analyzed to determine when concrete plant 104 starts and stops operating.

Various ways in which performance monitoring system 300 may operate to track the performance of various entities and stages of the concrete production process will now be described. The following will also describe how performance monitoring system 300 can utilize tracked data to estimate timing information (e.g., when a truck is expected to leave the yard after a ticket has been sent to batch control system 112 and when the plant 104 is available) that can be used to guide and improve the efficiency various operations at concrete plant 104 as well as improve the accuracy of various scheduling tasks performed by dispatch system 110. The following will further describe how performance monitoring system 300 can use tracked data to automate certain control operations at concrete plant 104.

Concrete Plant Tracking. Performance monitoring system 300 can track, for a given load, how long it takes for concrete plant 104 to perform weigh up and how long it takes to discharge. If weigh up is taking too long, then typically it is because concrete plant 104 is not hitting a target which could be caused by a mechanical issue or batching parameters in batch control system 112. There are not as many variables involved in discharge, but there can also be mechanical and batching parameters issues. For a given load, performance monitoring system 300 can retrieve the ticket time, the weigh up start time, the weigh up end time, the discharge start time, the discharge end time when the plant is available from batch control system 112 and/or batch control system database(s) 114 and use such information to determine for the given load: when the ticket was received, when the plant 104 was available, how long it took to perform weigh up, how long it took to discharge, and the amount of time that elapsed between after weigh up was complete and discharge started.

In a scenario in which concrete plant 104 is a wet mix plant, performance monitoring system 300 can track, for each load, how long the material used to make the load remained in the drum of the central mixer. This information may be determined, for example, based on information retrieved from batch control system 112 and/or batch control system database(s) 114. In another implementation, this information may be determined by tracking a number of revolutions that the central mixer made with the concrete in it. For example, a magnetic sensor may be installed proximate to the central mixer and used to sense the number of revolutions made by the central mixer for each load. Such information may then be used by performance monitoring system 300 to determine how many revolutions were made by the mixer or how long the material was in the drum.

Performance monitoring system 300 may also be used to prevent over batching of material by batch control system 112 when a cement tanker is being used to fill up a cement silo of concrete plant 104. Cement tankers must fill up the cement silos. Sometimes this happens at night, but it can also happen during the day, when concrete plant 104 is operating. To fill a silo, a truck driver hooks up a hose to the designated pipe that fills the silo and then causes the cement to be blown from the truck into the silo via the hose. This typically increases the air pressure in the silo itself. In a gravity fed plant, if weigh up is occurring when the silo is being filled, this will make the material come out faster. Consequently, batch control system 112 may end up putting more material in the weigh batch than necessary. To help prevent such over batching, performance monitoring system 300 may monitor the air pressure in the silo. If the air pressure level is determined to be high enough to cause over batching, then the maintenance department and plant operator may be notified.

If the air pressure in the silo gets too high, then it can actually split the silo or possibly blow cement out of the vent on the silo. Typically, the air pressure should be close to (9) nine psi for most concrete plants. If the air pressure is too low, then the cementitious material (cement, fly ash or slag) may weigh up too slowly if it is gravity fed (as opposed to augured). To address these concerns, performance monitoring system 300 may be configured to generate an alert or other notification if the air pressure in the silo is determined to be too low or too high.

Performance monitoring system 300 may also be configured to determine a difference between an expected or theoretical amount of material within a silo and the actual amount of material in the silo (e.g., silo 402, as will be described below with reference to FIG. 4), as measured by a silo sensor. This information can help the plant operator determine that one or more problems exist that are causing a loss of material in the batching process. The loss of materials may be due to a variety of factors including but not limited to: a lack of sufficient granularity in scale gradient size; blowing cementitious material into the silo; theft; a leaky gate; a scale venting issue; failure of one or more of the load cells used to weigh the material, or the like. By notifying the plant operator about the leaking of material in the batching process, the plant operator can address the issue before large amounts of materials are lost, thereby conserving a significant amount of cost and materials.

Plant Operator Tracking. Performance monitoring system 300 can track when the ticket was received by the batch control system 112 (from dispatch system 110) and when the plant is available versus when the plant operator starts weigh up for the load. For example, performance monitoring system 300 may obtain the time of ticket receipt, when the plant 104 was available, and when the weigh up started from batch control system 112 and/or batch control system database(s) 114 and use such information to identify the amount of lag between receipt of the ticket (or plant availability) and the starting of the weigh up of the load by the plant operator.

Performance monitoring system 300 can track when the concrete truck 108 is under concrete plant 104, and thus ready for discharge, versus when the plant operator initiates the discharge. As discussed above, a truck sensor (e.g., sensors 406A and 406B, as will be described below with reference to FIG. 4) may be installed at concrete plant 104 and used by performance monitoring system 300 to determine when the concrete truck 108 associated with a particular ticket is under the plant. Furthermore, performance monitoring system 300 may obtain information from batch control system 112 and/or batch control system database(s) 114 that indicates when discharge was initiated for that ticket. On a dry batch plant, performance monitoring system 300 can use this information to determine the lag, if any, between when the correct concrete truck 108 was under concrete plant 104 and when discharge began.

Performance monitoring system 300 can assist the plant operator when a concrete truck should be leaving the yard on time based on information obtained from batch control system 112 and/or batch control system database(s) 114. Performance monitoring system 300 may also store a default post-loading time that may be input by management. Performance monitoring system 300 may provide a countdown clock that starts counting down from the default post-loading time to zero when it is determined that discharge is complete. The countdown clock may be displayed, for example, on a monitor that is viewable by the plant operator or most importantly by the driver. In an alternate implementation, the countdown clock may be triggered based on detecting that the truck 108 has moved out from under concrete plant 104 as determined using the aforementioned truck sensor.

Performance monitoring system 300 can also track if the plant operator is freewheeling or not when there is an opportunity to do so. As discussed above, freewheeling involves the plant operator starting weigh up on a next ticket before discharge is complete with respect to a current ticket. Performance monitoring system 300 can identify a freewheeling opportunity based on information obtained from batch control system 112 and/or batch control system database(s) 114, wherein such information indicates that discharge is occurring with respect to a first ticket and there is concurrently a second ticket waiting for which weigh up may be initiated.

Performance monitoring system 300 can also determine when there is an opportunity for the plant operator to recapture a dry up load. A dry up load refers to additional material that is added to a load by the plant operator when it is determined (e.g., through slump testing or just a visual inspection) that the load is too wet. Typically this entails the driver pulling the truck 108 back under concrete plant 104 again so that the plant operator can dump additional material on top of the existing load. Typically, this dry up load is never recaptured which constitutes a loss of the additional material to the concrete producer.

Performance monitoring system 300 can determine (e.g., based on data from batch control system 112 and/or batch control system database(s) 114 that a dry up load was required to meet the desired concrete specification for the job. Performance monitoring system 300 can determine that a dry up load was required because typically the plant operator will manually create a dry up load by selecting a mix, load size and truck number. The mix ID will be a designed dry up mix for this particular plant. Alternatively, the plant operator will use the same mix for the dryup load that was previous batched. For example, assume that ½ yard of material has been added as a dry up load to a 10 yard load that was determined to be too wet. In such a scenario, when the next truck associated with the same order is under concrete plant 104, performance monitoring system 300 can remind the plant operator about the dry up load and ask the plant operator if he would like to recapture the ½ yard of material in the current load. If the plant operator responds in the affirmative, the performance monitoring system 300 will stop reminding the plant operator. The plant operator will need to return ½ yard of material using the returned concrete feature to reduce the amount of concrete batched by ½ yard relative to what the ticket specifies. For example, the second ticket may say 10 yards, but the truck will only have 9.5 yards on it. Bear in mind, however, that the first load had 10.5 yards of concrete on it, but the ticket had 10 yards of concrete. Thus, the customer still received exactly what they ordered (20 yards of concrete in this example).

Performance monitoring system 300 can also track when the plant operator first started operation of concrete plant 104 for the day versus when the plant operator started the first load. As noted above, performance monitoring system 300 may monitor an air gauge sensor installed at concrete plant 104 to determine when an air compressor used to power the gates of concrete plant 104 became operational, and thus determine when concrete plant 104 started operating for the day. As also noted above, other methods may be used to infer the time concrete plant 104 started operating. Performance monitoring system 300 may determine when the first load was started based on the time of ticket receipt which may be obtained from batch control system 112 and/or batch control system database(s) 114.

In an embodiment in which performance monitoring system 300 monitors an air gauge sensor installed at concrete plant 104, performance monitoring system 300 may also be configured to determine if the air pressure associated with the air compressor fails to meets a certain threshold or is otherwise outside of operational norms. For example, if the air pressure isn't high enough, then concrete plant 104 may not operate properly. In this case, performance monitoring system 300 can detect that the air pressure isn't high enough and automatically send out an alert to maintenance or management.

Performance monitoring system 300 can also track when the last load was handled by the plant operator versus when the plant operator closed concrete plant 104 for the day. Performance monitoring system 300 may determine when the last load was taken based on information obtained from batch control system 112 and/or batch control system database(s) 114. As noted above, performance monitoring system 300 may monitor an air gauge sensor installed at concrete plant 104 to determine when an air compressor used to power the gates of concrete plant 104 have stopped operating, and thus determine when concrete plant 104 has been shut down for the day. As also noted above, other methods may be used to infer the time concrete plant 104 stopped operating for the day.

Performance monitoring system 300 may provide the aforementioned information concerning when the plant operator first starts operation of concrete plant 104 and when the plant operator closes concrete plant 104. With existing systems, the dispatcher doesn't know if the plant operator is there until the ticket is sent. Unless they get an error message, then they don't know there is a problem. Performance monitoring system 300 can address this issue by indicating to the dispatcher whether concrete plant 104 is open or not. As another example, if the plant operator fails to turn off concrete plant 104 at the end of the day, then performance monitoring system 300 can notify someone in maintenance or the like.

Performance monitoring system 300 may also track any manual changes made to the mix by the plant operator. Performance monitoring system 300 may obtain this data from batch control system 112 and/or batch control system database(s) 114.

Driver Tracking. In a dry batch plant, performance monitoring system 300 may determine when a truck needs to be under in the proper position under concrete plant 104 prior to weigh up being complete. Performance monitoring system 300 may estimate the amount of time required to weigh up the material and the amount of time that is required for the head water. Typically, in a dry batch plant, the truck needs to be under concrete plant 104 approximately 30 seconds prior to the weigh up being complete. This is because it typically takes about 30 seconds for the head water to complete. If the truck is not in position at the proper time, then this wastes time and reduces the operational efficiency of concrete plant

In an embodiment, performance monitoring system 300 controls a timer present in the concrete truck (or otherwise viewable by the driver of the concrete truck) that shows the truck driver when he or she needs to be in the proper position. For example and without limitation, the timer may be a stand-alone device, a feature integrated into a GPS device already present in the concrete truck, or part of an application executing on a mobile computing device (e.g., smart phone or tablet) available to the driver of the truck. The timer may also be displayed on a monitor or digital display board that is visible to all drivers and that shows, for each driver, the corresponding time that the driver should be in position under concrete plant 104.

Performance monitoring system 300 may determine when the correct concrete truck is properly situated under the loading zone of concrete plant 104 such that the discharge may begin. As discussed above, a truck sensor may be installed at concrete plant 104 and used by performance monitoring system 300 to determine when the concrete truck associated with a particular ticket is under the plant. Likewise, performance monitoring system 300 may determine when an incorrect concrete truck is under the plant. In such a case, an error message may be provided to the plant operator. The error message may be displayed, for example, on a monitor that is viewable by the plant operator. Furthermore, if the driver of the correct truck is having difficulty backing up the truck into the proper position, performance monitoring system 300 may pass information gathered by the truck sensor (e.g., showing where the truck's rear wheels are relative to a correct position) to a device in the truck (e.g., the GPS device in the truck) to assist the driver in backing up the truck to the proper position.

Performance monitoring system 300 may track when the concrete truck arrived in the proper position under concrete plant 104 versus when the truck should have been in the proper position under concrete plant 104.

Performance monitoring system 300 may calculate that amount of time from when the discharge ended until when the truck pulls out from under concrete plant 104 based on data obtained from batch control system 112 and/or batch control system database(s) 114, while the time that the truck pulls out from under concrete plant 104 may be determined using the aforementioned truck sensor.

Performance monitoring system 300 may calculate the time from when the truck 108 pulls out from under the concrete plant 104 until it goes to the testing area (if there is testing). For example, the location of the concrete truck 108 may be tracked using the aforementioned truck sensor (e.g., sensors 406A and 406B). Alternatively, GPS data reported by a GPS device on the truck or by GPS truck tracking system 116 may be used to determine truck location. As previously discussed, the identity of the truck may be determined using, e.g., QR codes, barcodes, data matrix codes, Bluetooth, UWB, RFID, NFC, or the like.

Performance monitoring system 300 may also determine how long a driver is spending in the testing area of concrete plant 104, how long it takes for a truck 108 to transition from the testing area of concrete plant 104 to the slump rack (e.g., slump rack 428, as will be described below with reference to FIG. 4) (or inspection station) of concrete plant 104, how long a driver is spending at the slump rack 428 of concrete plant 104, and how long it takes for a truck to transition from the slump rack (or inspection station) of concrete plant 104 to departing concrete plant 104. For example, the location of the concrete truck 108 may be continuously tracked using the aforementioned truck sensor. Alternatively, GPS data reported by a GPS device on the truck or by GPS truck tracking system 116 may be used to determine truck location. As previously discussed, the identity of the truck 108 may be determined using, e.g., QR codes, Bluetooth, RFID, NFC or the like.

Performance monitoring system 300 may display a countdown timer to the driver to show how much of an allocated testing time is left while the truck is at the testing area. Likewise, performance monitoring system 300 may display a countdown timer to the driver to show how much of an allocated slump rack time is remaining while the truck is at the slump rack (or inspection station). For example and without limitation, the countdown timer may be a stand-alone device, a feature integrated into a GPS device already present in the concrete truck, or part of an application executing on a mobile computing device (e.g., smart phone or tablet) available to the driver of the truck. The countdown timer may also be displayed on a monitor or digital display board that is visible to all drivers and that shows, for each driver, the amount of time the driver has left in the testing area or at the slump rack and inspection station.

In some scenarios, if concrete plant 104 is busy, then a driver may take a brief break in a driver room. Performance monitoring system 300 can determine when the driver should be back in the truck 108 to take the next load based on data obtained from batch control system 112 and/or batch control system database(s) 114, including data pertaining to the tickets ahead of the driver's ticket. In some embodiments, the recommended time may be presented on a monitor or digital display board (e.g., located in or around the driver room) that is visible to all drivers and that shows, for each driver waiting, the recommended time to return to their truck.

Performance monitoring system 300 can also determine whether a truck driver needs to go to the testing area for testing and can display such information via a monitor or digital display board that is visible to all drivers at concrete plant 104. Such monitor or digital display board may also show the driver where to go for testing. If testing was added to the ticket by the dispatcher (using the aforementioned load customization feature of dispatch system 110), then performance monitoring system 300 can determine that by accessing the ticket information from batch control system 112 and/or batch control database(s) 114. For example, such ticket information may indicate “air test” or “slump test”. If testing is unscheduled, then the plant operator may input a delay reason into performance monitoring system 300 (e.g., via performance monitoring dashboard 308) and the driver may be duly notified and routed to the testing or the slump rack area.

Dispatcher Tracking. Performance monitoring system 300 can track the time between tickets being issued by the dispatcher via dispatch system 110 and received by batch control system 112. Such information may be obtained from batch control system 112 and/or batch control system database(s) 114. Such information can indicate whether the dispatcher is sending tickets in large groups (e.g. 4 to 5 tickets at a time) in order to facilitate taking a break, which is not a good practice. Typically, there should not be more than 2 to 3 tickets on the ticket stack, as this enables the dispatcher to dynamically adapt to minute by minute changes that may influence subsequently-issued tickets. If the dispatcher issues 4 to 5 tickets and then goes on a break, things may change while the dispatcher is on break and then tickets may need to be deleted, etc.

Performance monitoring system 300 can track how many tickets the plant operator currently has on the stack of batch control system 112 or if a ticket is in the middle of the batching process. Ideally, the plant operator should always have two tickets on the stack (if there is enough demand and there is an available truck in the yard), but not more than three at any time. If there is another truck in the yard and there is not another ticket on the stack (beyond the current ticket that is in the batching process), then performance monitoring system 300 may generate a message that is sent to the dispatcher indicating the he is slowing up the production process. For the plant operator to “freewheel” or “fast batch” there has to be another ticket on the ticket stack of batch control system 112 for the plant operator to start the weigh up of the next ticket prior to discharge of the current ticket. Performance monitoring system 300 may obtain this information from batch control system 112 and/or batch control system database(s) 114.

As noted above, performance monitoring system 300 can determine when a ticket is sent and, based on such information, determine when the truck should leave the yard. In an embodiment, this information may be passed back to dispatch system 110 so that such information can be taken into account in scheduling delivery times for future loads.

Performance monitoring system 300 can also use the information about when the truck should leave the yard to generate an estimate of when the truck should be at jobsite 106. Performance monitoring system 300 can then forward this information to dispatch system 110, enabling the dispatcher to notify the customer if the projected delivery time varies from that previously determined by dispatch system 110. In some embodiments, the customer may be provided with an application that shows when the truck 108 should arrive at jobsite 106 based on information tracked by performance monitoring system 300.

In a scenario in which concrete plant 104 is a central mix plant, performance monitoring system 300 can analyze the dispatch schedule and determine therefrom that there is a break in the schedule that is sufficiently long to justify shutting down the central mixer to conserve power. In such a case, performance monitoring system 300 can send a message to the plant operator that notifies the plant operator of the opportunity to shut down the central mixer, and based on such message, the plant operator can determine whether or not to shut down the central mixer. In an alternate embodiment, performance monitoring system 300 may be configured to automatically shut down the central mixer itself based on a determined break in the schedule.

Loader Operator Tracking. Performance monitoring system 300 can track the performance of the loader operator. The loader operator is responsible for keeping the material bins full on the concrete batch plant 400. The performance monitoring system 300 can read the error messages in the batch control system to determine if the material in the bin in the concrete plant went empty during the weigh-up process. Performance monitoring system 300 can determine when a bin is full in a number of ways and then track the amount of material dispensed from the bin for each load. Performance monitoring system 300 can calculate or estimate the amount of material in the material bin and issue a notification to the loader operator or plant operator when the amount of material is getting too low to service one or more future loads. Typically, there is a field hopper at the bottom of the conveyor that the front end loader uses to send the material to the material bin on the plant. To determine when the bin is full, performance monitoring system 300 may utilize a high bin indicator if such high bin indicator is installed on the bin. Once the material reaches the high bin indicator then the material handling system with automatically shut the gate of the field hopper at the bottom of the conveyor. Typically, the conveyor belts run until the belts are clear of material. Performance monitoring system 300 may also utilize other methods or sensors (e.g., a real time plant bin material sensor) to determine the actual amount of material in the bin at any given time. Performance monitoring system 300 could calculate how much material is in each bin or when the bin is going to run out of material. A material gauge could be used to display the amount of material in the plant bin for everyone to see on an outdoor monitor or display. One of the challenges in displaying the amount of material in the material bin is keeping track of how much material the loader has added to the material bin since the last time that the material bin was full. The material gauge could also be used for the field hopper, outside material bin or underground material bin. If there is no real-time bin sensor that shows the amount of material in the bin, then performance monitoring system 300 will not know the exact amount of material in the bin. Typically a loader operator fills one material at a time. If a real-time sensor is not used, then there could be a tablet (or smart phone) mounted in the cab of the loader. The loader operator could keep track of every time a scoop of material is conveyed to the overhead bin. The amount of material in the loader bucket could also be determined via a load cell on the loader. There could also be a material conveyor sensor at the top of the sensor. A calculation could be made to determine how much material is added after the material hit the high bin indicator level. There could also be a monitor in the drivers room, an outdoor location or a notification could be sent to the tablet or smartphone that tells the loader operator that the bins are getting low. Performance monitoring system 300 could also keep track of when the loader operator came to work vs when the first load was taken or when the last load was batched versus when the loader operator quit for the day. Typically, the plant should be left full. But, if the weather is cold and the material is frozen then the plant bin should be left empty and the loader operator needs to be arrive before the first load is batched. Performance monitoring system 300 could use a number of different methods such as a conveyor sensor or other electronic sensors to figure out when the loader operator started his day versus when the first load was batched. Performance monitoring system 300 could use a number of different methods to determine when the last load of the day versus when the loader operator finished his day. It's also not uncommon for customers to show up in a pickup truck at concrete plants to pick up some landscaping rock. One of the challenges is that the loader operator doesn't always know who came in the yard first. The order could just show up on the tablet or smart phone mounted in the cab of the loader. The orders would disappear once the orders are fulfilled.

Quality Control. Performance monitoring system 300 can track how long a truck is in testing. Both quality control and the driver play a role in this process. As discussed above, a truck sensor may be used to track the location of the truck while at concrete plant 104 and thus determine how long the truck is at the testing station. Alternatively or additionally, Bluetooth communication with a Bluetooth device located on the driver or the truck (e.g., a Bluetooth keychain) may be used to determine driver/truck location. Still further, GPS data reported by a GPS device on the truck may be used to determine truck location.

Performance monitoring system 300 can also track how often testing is scheduled versus unscheduled. If testing was added to the ticket by the dispatcher (using the aforementioned load customization feature of dispatch system 110), then performance monitoring system 300 can determine that by accessing the ticket information from batch control system 112 and/or batch control database(s) 114. For example, such ticket information may indicate “air test”, “slump test” or “air and slump test.” If testing is unscheduled, then the plant operator may input a delay reason into performance monitoring client 302 and the driver may be duly notified and routed to the testing or the slump rack area.

Management. Performance monitoring system 300 can provide a snapshot view of concrete production via performance monitoring dashboard 308 that can be used by management to efficiently determine how a particular dispatcher, concrete plant, plant operator, loader operator or truck driver is performing at any given time.

Process Timing Estimation. As noted above, performance monitoring system 300 can estimate and track the timing of events (e.g., a time that a truck will leave the plant) that can then be used to guide and improve the efficiency of various operations at concrete plant 104 as well as improve the accuracy of certain scheduling tasks performed by dispatch system 110.

Concrete is sold by volume and measured by weight. When a ticket is received by the batch control system 112, then performance monitoring system 300 can determine the number of aggregates, cements, admixtures, and water. The quantity of material may be sent to batch control system 112 by dispatch system 110, or dispatch system 110 may send a mix ID to the batch control system 112 can determine the quantity of each material based thereon. Based on the quantity of material, performance monitoring system 300 can determine how long that it typically takes to weigh up (or meter liquids such as admixtures) each material. Performance monitoring system 300 may also determine approximately how many times the gates are going to jog (open and close) to achieve the correct weight and how much time that it takes for the scale to settle to read the proper weights from the plant scale. Using historical analysis, performance monitoring system 300 can determine how long the weigh up and discharge process is going to take.

Performance monitoring system 300 can likewise estimate and track how long it is going to take from the time that the ticket was received by batch control system 112 until the truck is going to exit the yard. In a dry batch plant 104, performance monitoring system 300 estimates the amount of time for the plant operator to start the load, the amount of time for the concrete plant 104 to weigh up (as discussed in the preceding paragraph), the amount of time that the driver takes to pull under plant 104, the amount of time for the plant to dispense the headwater, the amount of time for when the plant operator presses the discharge button, the amount of time the plant 104 discharges material into a mixer truck (including tail water) and amount of time that the driver is going to spend at the slump rack prior to leaving the yard (e.g., based on driver history). Performance monitoring system 300 can also determine if there are additional loads (or tickets) in front of the existing ticket. Today, concrete producers don't know exactly when the truck should leave the yard after the ticket has been received, nor do they have a way to track it. This has never been done before. In an embodiment, this information may be provided to dispatch system 110 to facilitate more accurate automated dispatch scheduling and truck tracking.

Providing accurate estimates of the time the truck will leave concrete plant 104 to dispatch system 110 can enable dispatch system 110 to tighten up the delivery schedule. Conventional dispatch systems make assumptions that are not always true. At the plant level, one can input a default value for ticket time, loading time and slump rack time into the dispatch system. However, a conventional dispatch system doesn't consider is if there are tickets already stacked on the batch system or how long it takes to batch a load. Most dispatch systems don't know if there is testing. Conventional dispatch systems also don't know the exact time that it takes to batch the load. Conventional dispatch systems don't know if the load needs to be double batched (which takes longer). Conventional dispatch systems just use default values.

To further explain, dispatch system 110 may operate based on assumptions that are not always true. For example, dispatch system 110 may schedule based on default values for ticket time, loading time and slump rack time. In further accordance with this example, dispatch system 110 may utilize a default 5-minute ticket time and a 5-minute loading time. However, if the dispatcher is sending the first ticket of the day, then dispatch system 110 is giving away at least 4 minutes because it's not necessary. On the counter side to this if there are two loads in front of the existing ticket then it will likely take 5 minutes longer to batch than the default parameters that are in the dispatch system. Performance monitoring system 300 can obtain a much better understanding of how long it will take to get the truck out of the yard when the ticket is sent and when the plant is available. Performance monitoring system 300 may also consider whether there is testing. Performance monitoring system 300 can also determine if there is additional time is needed for adding fiber to the load that is typically not part of the batching process. Performance monitoring system 300 can provide such information to dispatch system 110 to enable dispatch system 110 to make better scheduling decisions. Performance monitoring system 300 may also provide a message to the driver to tell them when they are expected to be at jobsite 106. Such information is not provided to drivers in conventional systems.

In an additional embodiment, an application may be provided for use by customers of the concrete producer, wherein the application can provide the customer with periodic updates about when the next load of concrete is likely to arrive based on the aforementioned time estimate capability of performance monitoring system 300.

Enhanced Process Controls. As noted above, performance monitoring system 300 can use tracked data to automate certain control operations at concrete plant 104.

For example, based on the combination of understanding when weigh up is complete for a given load, and the knowledge that the correct truck 108 is under concrete plant 104, performance monitoring system 300 can automatically trigger discharge of the load into the truck. For example, performance monitoring system 300 may be configured to leverage certain built in interlocks of batch control system 112 that support remote batching to automatically trigger discharge of the load into the truck. Alternatively, performance monitoring system 300 can cause a notification to be displayed to the plant operator indicating that discharge can start and giving the plant operator the option to start discharge.

As another example, based on information obtained from a truck sensor, performance monitoring system 300 can determine that no truck 108 or an incorrect truck 108 is under concrete plant 104 or if truck mixer drum spinning the wrong direction (in discharging mode) or if the truck drum is not spinning fast enough when the plant operator has initiated discharge. In this case, performance monitoring system 300 may automatically delay the discharge of material into truck 108. In accordance with such an implementation, if the plant operator is busy during the weigh up process, then the plant operator could initiate discharge (e.g., by pressing a loading button) before the correct truck is in the truck loading area under concrete plant 104. Performance monitoring system 300 could ensure that discharge does not start until the proper truck is in the proper position. This can help to ensure that no time is wasted while the plant operator is otherwise occupied.

As another example, based on the determination that an opportunity for freewheeling exists (as discussed above), performance monitoring system 300 can automatically notify the plant operator to start weigh up the next load while batch control system 112 is still discharging the current load.

As another example, based on the determination that an opportunity for recapturing a dry up load exists (as discussed above), performance monitoring system can send a message to the plant operator to recapture the dry up load. In response to receiving such a message, the plant operator may utilize a “returned concrete” feature of batch control system 112 to recapture the dry up load. The “returned concrete” feature is typically designed to allow the plant operator to put a new concrete load on top of a partial returned load. However, in the case of recapturing a dry up load, the plant operator isn't actually putting a new concrete load on top of a partial returned load. Rather, the plant operator is leveraging the “returned concrete” feature to indicate to batch control system 112 that there is already a partial load in the truck that isn't actually there, wherein the amount of the partial load is specified to be the same as the amount of the dry up load to be recaptured.

Specialized Hardware for Tracking Weigh Up Start Time, Weigh Up End Time, Discharge Start Time, and Discharge End Time. Performance monitoring system 300 may utilize various methods to track, for a given load, the weigh up start time, the weigh up end time, the discharge start time, the discharge end time, and additional plant data such as when the first scale (or when plant becomes available) when the ticket was received may be required to deploy performance monitoring system 300. In some aspects, batch control system 112 may not be configured to track such data, or it may be configured to track such data, but the data may not always be reliable (for example, there may be a disparity between the time at which batch control system 112 determines weigh up started and when weigh up actually started). Also, batch control system 112 may track such data but may not record it in a manner that is readily accessible to performance monitoring system 300. To address these issues, plant monitoring devices 304 of performance monitoring system 300 may include specialized hardware that assist performance monitoring system 300 in tracking, for a given load, the weigh up start time, the weigh up end time, the discharge start time, the discharge end time, and additional plant data, such as when the plant became available or when the operator pushed the weighup or discharge button. Some of these approaches will now be described.

In some aspects, a manual station of batch control system 112 may be configured to read data from the scales used for weigh up and may pass such data to a batch PC. In accordance with such a scenario, performance monitoring client 302 may be adapted to “sniff” (i.e., capture a copy of) the scale data that is passed from the manual station to the batch control system 112 in real time. This scale data can be used, for example, to determine weigh up start time, weigh up end time, discharge start time, or discharge end time.

In some aspects, performance monitoring client 302 may be adapted to “sniff” scale data that is passed from the scale head to a PLC or RTC of batch control system 112.

In some aspects, the states of the valves (or gates) that are used to feed material from the overhead bins to the scales may be monitored to determine when the flow of materials from the bins to the scales is initiated (which may indicate the start of weigh up) and when it is stopped (which may indicate the end of weigh up). Likewise, the state of the valves (or gates) that are used to discharge materials from the bottom of the weigh batchers may be monitored to determine when the flow of materials from the weigh batchers is initiated (which may indicate the start of discharge) and when it is stopped (which may indicate the end of discharge).

In some aspects, the state of the aforementioned valves could be monitored by establishing a connection to the limit switches used to open or close the valves. The state of the limit switches can indicate if the valves are fully closed or fully opened. In other embodiments, a special device could be used to read each scale directly.

In some aspects, a camera could be installed near the plant junction box or the batch house junction box. A connection may also be established with a red light that lights up in the plant junction box or the batch house junction box.

In still further embodiments, a camera may be installed near the overhead gates and the gates on the weight batcher.

In some aspects, an audio capture device (e.g., a microphone) could be installed proximate to the weigh batcher and the audio captured thereby could be monitored to determine when material hits the weigh batcher.

In some aspects, the type of material being loaded and hauled by a truck (e.g., a loader, a cement tanker, etc.) may be tracked. This can be referred to as “material tracking.” For instance, each area of a concrete plant (e.g., concrete plant 104) that stores a particular type of aggregate material may have an RFID or NFC reader. For example, an area of concreate plant 104 that stores fine aggregate may be associated with a first RFID or NFC reader, and an area of concreate plant 104 that stores coarse aggregate may be associated with a second RFID or NFC reader. Before, during, or after material (e.g., aggregate material) is loaded into a bucket of a loader, the RFID or NFC tag of the loader may be scanned by the RFID or NFC reader that is in the area in which the loader is loaded with material. The identification of the loader along with the material being loaded into the loader may be provided to performance monitoring system 300.

Knowing which material is being hauled by a loader enables the determination as to whether the proper material is being loaded in a proper bin. For instance, material from a loader may be loaded onto a single material conveyor belt. In some instances, a turn head coupled to material conveyor belt directs the material to the appropriate bin. For instance, if aggregate material is loaded onto the material conveyor belt, the turn head would be in a first position that causes the material to be loaded into a first bin. If aggregate material is loaded onto the material conveyor belt, the turn head would be in a second position that causes the aggregate to be loaded into a second bin. In some instances, concrete plants 114 will utilize moveable conveyors commonly referred to as a radial stacker system. High production concrete plants also use dedicated conveyors for each bin.

Before material is loaded on the material conveyor belt, the RFID or NFC tag of the loader hauling the material may be scanned to determine the type of material the loader is hauling. The position of the turn head may also be determined (e.g., visually using a camera, reading signals provided by the turn head, etc.). If the position of the turn head does not correspond to the type of material being hauled by the loader or if the loader operator is putting the wrong material into the wrong material hopper, an alert or other notification may be generated. Alternatively, an identifier of the loader obtained by reading the NFC or RFID tag may be provided to performance monitoring system 300, which determines the type of material being hauled by the loader. Performance monitoring system 300 may send a signal to a turn head controller that indicates the type of material being hauled by the loader. In response to receiving the signal, the turn head controller causes the turn head to be placed in the position that corresponds to the type of material.

Knowing where the cementitious material was loaded into the cement tanker allows performance monitoring system 300 to determine what type of cementitious material is being hauled in the cement tanker also enables the determination as to whether the proper cement (which includes cement, flyash or slag or any other type of cementitious material) is being blown into the proper silo. For instance, different silos may be utilized to store a different type of cementitious material. Before a particular silo is filled with cementitious material, the RFID or NFC tag of the truck hauling the material may be scanned to determine the type of material the cement tanker is hauling. An identifier of the cement tanker obtained by reading the NFC or RFID tag may be provided to performance monitoring system 300. Determining where the truck picked up the material using GPS technology typically determines the type of material being hauled by the truck. When the silo is being filled with the cementitious material, the air pressure of the silo changes. An air gauge sensor located in the silo may detect the air pressure change and generate a signal that is provided to performance monitoring system 300. Based on the signal generated by the air gauge sensor and the cementitious material being hauled, performance monitoring system 300 may determine the type of material that is being filled in the silo. If the material being filled in the silo is not the material designated for that silo, an alert or other notification may be generated.

It is noted that other tracking techniques may be utilized in addition to or in lieu of RFID and NFC-based techniques, including, but not limited to, GPS devices, QR code-based techniques, Bluetooth-based techniques, etc.

In some respects, the status of hatches of a cement tanker may be tracked to determine long it takes to load the cement tanker. For example, a sensor (e.g., a proximity switch) may be coupled to each hatch (could be 2 or 3 hatches per cement tanker) on a cement tanker. The sensor may detect whether the hatch coupled thereto is opened or closed. Typically, the driver of the cement tanker will take off the hatch of the cement tank just prior to be loaded and the driver will put the hatch back on immediately after the tanker is loaded. Truck driver's typically don't want the material in the tanker to get contaminated. The sensor may generate a signal each time a hatch coupled thereto is opened and/or closed. The signal may indicate a time and/or date at which the hatch was opened and/or closed. The signal may be provided to performance monitoring system 300. Based on the signals received from the sensors, performance monitoring system 300 may generate an alert if it determines that the truck is moving while at least one of its hatches is opened.

### E. System for Determining that a Mixer Truck or Dump Truck is Under a Concrete Plant

FIG. 4 is a block diagram of a system 400 for determining that a truck is under a silo, according to some embodiments. As shown in FIG. 4, system 400 comprises a silo 402, a truck 404, sensors 406A and 406B, a cement batcher 408, an aggregate batcher 410, an aggregate conveyor 412, and a slump rack 428. Silo 402, sensors 406A and 406B, cement batcher 408, aggregate batcher 410, aggregate conveyor 412, and slump rack 428 may be part of a plant (e.g., concrete plant 104). However, it is noted that the embodiments described herein are also applicable to other types of plants, for example, asphalt plants and aggregate plants. Silo 402 may store cement or another type of building material. Silo 402 may be raised and supported via one or more support structures (e.g., support structures 414A and 414B). Support structures 414A and 414B may comprise steel beams, pipe legs, and/or the like.

Silo 402 may be coupled to cement batcher 408. The cement stored in silo 402 is provided to cement batcher 408 and subsequently discharged into a truck hopper 416 of truck 404. Cement batcher 408 may comprise a gate 420 that may be automatically opened upon detecting that truck hopper 416 is located under gate 420. In the example shown in FIG. 4, gate 420 is shown to be opened, thereby enabling cement from cement batcher 408 to dispense into truck hopper 416. Truck hopper 416 may also be configured to receive aggregate material dispensed in aggregate batcher 410. For instance, aggregate placed in aggregate batcher 410 may be dispensed in aggregate conveyor 412. Aggregate conveyor 412 may be an automated conveyor belt (or other means for conveying) that transports the aggregate to truck hopper 416. The material dispensed into truck hopper 416 (e.g., cement and/or other aggregate material) may be dispensed into a mixer drum 418 of truck 404.

One or more sensors (e.g., sensors 406A and 406B) of plant monitoring devices 304 may be utilized to determine whether truck hopper 416 is under a loading point, such as under gate 420 of cement batcher 408. In some embodiments, one or more of sensors 406A and 406B are photoelectric sensors, where one sensor is configured to emit a beam of light (e.g., an infrared beam) and another sensor is configured to receive the beam of light. As shown in FIG. 4, sensors 406A and 406B are attached to support structures 414A and 414B, respectively. However, it is noted that sensors 406A and 406B may be attached to another support structure (e.g., a gantry, a support frame, a scaffold, etc.) that may or may not be coupled to support structures 406A and 406B.

When an object interrupts or reflects the emitted light, the presence of the object (e.g., truck hopper 416) is determined. The distance from the ground at which sensors 406A and 406B are located may correspond to the distance at which a portion of truck hopper 416 is located from the ground. To accommodate trucks of varying sizes, sensors 406A and 406B may be adjusted horizontally (e.g., moved a particular distance in a horizontal direction) and/or vertically (e.g., moved a particular distance in a vertical direction). For instance, the type of truck scheduled to be under silo 402 for material discharge may be known based on the ticket assigned to the truck. Based on the type of truck, performance monitoring backend 306 may send a command to a processor (not shown) that causes the support structure(s) to which sensors 406A and 406B are attached to be horizontally and/or vertically adjusted. As described above, other portions of truck 404 may be utilized to determine whether truck 404 is under silo 402. For example, the presence of rear wheels 422 of truck 404 may be detected to determine whether rear wheels 422 are located relative to a correct position of truck hopper 416. In accordance with such an example, sensors 406A and 406B may be positioned lower to the ground such that they will be aligned with wheels 422. It is noted that different types of sensors 402A and 402B may be utilized, including, not but not limited to, photodetector-based sensors (e.g., configured to detect variations in light caused by an object being placed proximate thereto), inductive-based sensors (e.g., configured to detect disruptions in the electromagnetic field emanating from the sensors caused by an object being placed in proximity thereto), ultrasonic-based sensors (e.g., configured to emit soundwaves to detect objects), and/or cameras (e.g., that capture images that are processed utilizing object recognition techniques to detect, for example, truck hopper 416 or wheels 422 of truck 404).

Upon detecting the presence of an object (e.g., truck hopper 416), sensors 402A and/or 402B may transmit a signal to a processor 424 of cement batcher 408. Responsive to receiving the signal, processor 424 may send a signal to gate 420 that causes gate 420 to open, thereby causing material from material batcher 408 to dispense into truck hopper 416 and mixer drum 418. In some embodiments, sensors 406A and/or 406B may send the signal to performance monitoring backend 306 and/or batch control system 112, for example, via a wired and/or wireless network, and performance monitoring backend 306 and/or batch control system 112 may send a signal to gate 420 (e.g., via processor 424) causing gate 420 to open.

Upon detecting the presence of an object (e.g., truck hopper 416), sensors 402A and/or 402B may also transmit a signal to a processor 426 of truck 404. Responsive to receiving the signal, processor 426 may send a signal to mixer drum 418 that places mixer drum 418 in a charging mode, which causes mixer drum 418 to rotate at a first predetermined speed (e.g., 12 to 18 revolutions per minute). In some embodiments, sensors 406A and/or 406B may send the signal to performance monitoring backend 306, for example, via a wired and/or wireless network, and performance monitoring backend 306 may send a signal to processor 426 causing mixer drum 418 to be placed in the charging mode. The signal to place mixer drum 418 in the charging mode may sent before providing the signal to gate 420. This way, mixer drum 418 will be in the charging mode before material is dispensed therein. In some embodiments, processor 426 may convey the state of mixer drum 418 (e.g., a direction of rotation, a speed at which mixer drum 418 is rotating, a mode that mixer drum 418 is in, etc.) to performance monitoring backend 306 before processor 426 transmits the signal to mixer drum 418. As such, performance monitoring backend 306 may determine whether mixer drum 418 is already rotating and determine the speed and direction in which mixer drum 418 is rotating. Processor 426 may determine whether mixer drum 418 is in the proper state for cement discharge. If processor 426 determines that mixer drum 418 is not in the proper state, processor 426 may send a command to mixer drum 418 to place it in the proper state (e.g., to ensure that mixer drum 418 is rotating in the proper direction and at the proper speed).

In some embodiments, the signals are transmitted to and/or from processors 424 and/or 426, performance monitoring system 306, or batch control system 112 in response to determining that the object is present for a predetermined time period (e.g., 5 seconds, 10 seconds, etc.). This prevents false positives that are caused by transient objects (e.g., debris, birds, etc.).

After material is dispensed into mixer drum 418, processor 424 may send a signal to processor 426 (either directly or indirectly via performance monitoring backend 306) that causes mixer drum 418 to be placed in an agitate mode, which causes mixer drum 418 to rotate at a second predetermined speed that is slower than the first predetermined speed (e.g., less than 12 revolutions per minute).

Once mixer drum 418 is placed in agitate mode, the driver may drive truck 404 to slump rack 428. Upon determining that truck 404 is proximate to (e.g., adjacent to) slump rack 428, mixer drum 418 may be automatically placed in charging mode again. Moreover, a countdown timer may be displayed to the drive that indicates an amount of time that truck 404 is to be proximate to slump rack 428. For example, performance monitoring backend 306 may send a signal to processor 426 that causes mixer drum 418 to be placed in charging mode and may send a signal to display configured to display the timer that starts countdown timer. Truck 404 may be determined to be located on slump rack 428 using various techniques, including, but not limited to, GPS truck tracking system 116, Bluetooth signals, RFID or NFC tags, etc.

In some embodiments, before material is discharged to truck hopper 416 via cement batcher 408 and aggregate batcher 410, a determination may be made whether the correct truck is under the truck charging point. For example, an identifier of truck 404 may be obtained. The identifier may be compared to an identifier associated with a ticket issued to a truck that is scheduled for material discharge. If the identifiers match, then it may be determined that the correct truck is under truck hopper 416. The identifier of truck 404 may be obtained via a QR code located on truck 404, by scanning an RFID tag located on truck 404, by analyzing Bluetooth signals emitted by a transceiver coupled to truck 404, etc.

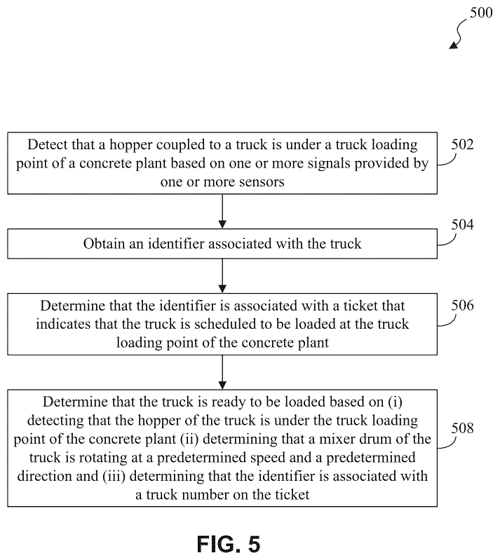

FIG. 5 is a flowchart of an example method for determining that a truck is under a silo, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to performance monitoring system 300 of FIG. 3 and system 400 of FIG. 4. However, method 500 is not limited to those example embodiments.

In 502, performance monitoring backend 306 may detect that hopper 416 of a truck (e.g., truck 404) is under a truck loading point of a concrete plant (e.g., gate 420 of cement batcher 408 of a cement plant) based on one or more signals provided by one or more sensors (e.g., sensors 406A and/or 406B) of plant monitoring devices 304. In some embodiments, the one or more sensors comprise one or more photoelectric sensors, one or more photodetector sensors, one or more inductive sensors, one or more ultrasonic sensors, or one or more cameras.

In 504, performance monitoring backend 306 may obtain an identifier associated with the truck. In some embodiments, performance monitoring backend 306 may obtain the identifier by obtaining the identifier based on a code associated with the truck, obtaining the identifier from a tag associated with the truck, and/or obtaining the identifier based on a wireless signal associated with the truck.

In 506, performance monitoring backend 306 may determine that the identifier is associated with a ticket that indicates that the truck is scheduled to be loaded at the truck loading point of the concrete plant (e.g., scheduled for material discharge from material batcher 408 located at the loading point). For example, in some embodiments, performance monitoring system 300 may obtain a ticket for a truck scheduled for material discharge, for example, from batch control system 112. The ticket may include an identifier of the truck. Performance monitoring system 300 may compare the identifier of the ticket with the identifier obtained at 504 and determine whether the identifiers match.

In 508, performance monitoring backend 306 may determine that the truck is ready to be loaded based on (i) detecting that hopper 416 is under the truck loading point of the concrete plant (e.g., under gate 420 of the loading point), (ii) determining that mixer drum 418 of truck 404 is rotating at a predetermined speed and a predetermined direction, and (iii) determining that the identifier is associated with a truck number on the ticket.

In some embodiments, performance monitoring backend 306 may send a control signal to processor 424 communicatively coupled to one or more material batchers (e.g., cement batcher 408 and aggregate batcher 410), wherein the control signal causes one or more gates (e.g., gate 420) of the material batcher(s) to open, thereby causing material (e.g., cement and aggregate) to dispense into hopper 416 of the truck (e.g., truck 404).

In some embodiments, performance monitoring backend 306 may send a control signal to processor 426 communicatively coupled to mixer drum 418 of the truck that causes mixer drum 418 to rotate at another predetermined speed and another predetermined direction (e.g., mixer drum 418 may be placed in the charging mode).

In some embodiment, performance monitoring backend 306 may, prior to the truck being proximate to slump rack 428, send a first control signal to processor 426 communicatively coupled to mixer drum 418 of the truck that causes mixer drum 418 to rotate at another predetermined speed and another predetermined direction (e.g., mixer drum 418 may be placed in agitate mode), and may, after determining that the truck is proximate to slump rack 428, send a second control signal to processor 426 that causes mixer drum 418 to rotate in accordance with a charging mode).

In some embodiments, performance monitoring backend 306 may determine that the truck is proximate to slump rack 428, may determine an amount of time that the truck is to be proximate to slump rack 428, and may cause a timer to be displayed via a display in accordance with the amount of time.

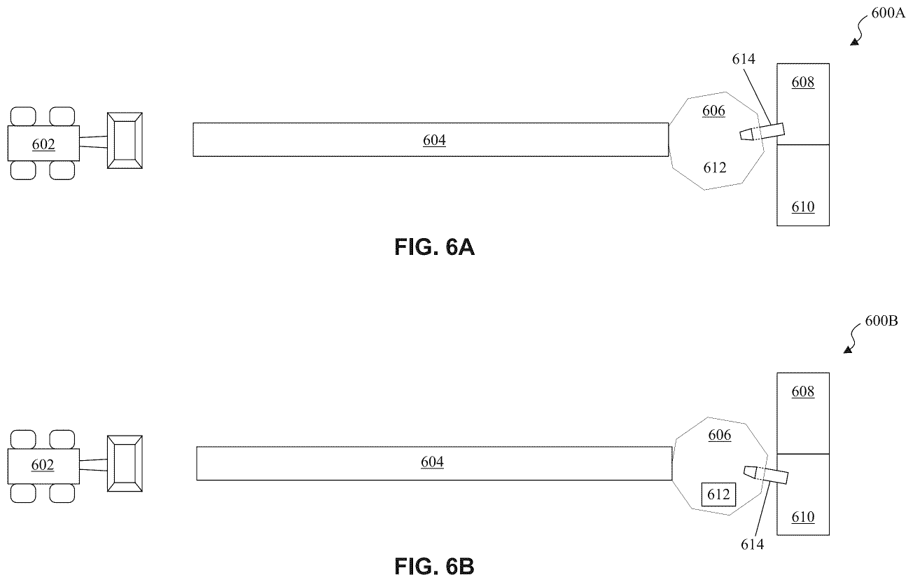

FIGS. 6A and 6B are block diagrams of systems 600A and 600B for ensuring that the proper material is loaded in a proper bin, according to some embodiments. In particular, FIGS. 6A and 6B depicts overhead views of systems 600A and 600B. As shown in FIGS. 6A and 6B, systems 600A and 600B comprise a loader 602 a material conveyor 604, a turn head 606, a first material bin 608 and a second material bin 610. Turn head 606 may be configured to direct the material being conveyed on material conveyor 604 to the appropriate bin of first material bin 608 and second material bin 610. For instance, if a first type of material (e.g., aggregate) is loaded onto material conveyor 604 from loader 602, turn head 606 is placed in a first position that causes the first type of material to be loaded into first material bin 608, as shown in FIG. 6A. If a second type of material (e.g., an aggregate material) is loaded onto material conveyor 604, turn head 606 is placed in a second position that causes the second type of material to be loaded into second material bin 610, as shown in FIG. 6B. It is noted that while FIGS. 6A and 6B depict two material bins, any number of bins may be utilized and turn head 606 may be placed into a plurality of different positions, each corresponding to respective bin. It is further noted that loader 602 may pour the material in a ground hopper (not shown for brevity), which conveys the material to material conveyor 604 rather than pouring the material directly on material conveyor 604.

Before material is loaded on material conveyor 604, the identifier of loader 602 may be determined, for example, via scanning an RFID or NFC tag of loader 602. The identifier of loader 602 may be provided to performance monitoring backend 303 via one or more networks. Performance monitoring backend 303 may determine the material being hauled by loader 602 based on the identifier to determine the type of material loader 602 is hauling. If the position of turn head 606 does not correspond to the type of material being hauled by loader 602 or if the loader operator is putting the wrong material into the wrong material hopper, an alert or other notification may be generated. In addition to or in lieu of generating an alert, performance monitoring backend 303 may send a signal to a turn head controller 612 of turn head 606 that indicates the type of material being hauled by the loader. In response to receiving the signal, turn head controller 612 causes the turn head to be placed in the position that corresponds to the type of material so that the material is loaded into the proper bin of first material bin 608 and second material bin 610. For instance, turn head 606 may be rotated such that a chute 614 of turn head 606 is aligned with the proper bin.

### F. Example Computer System

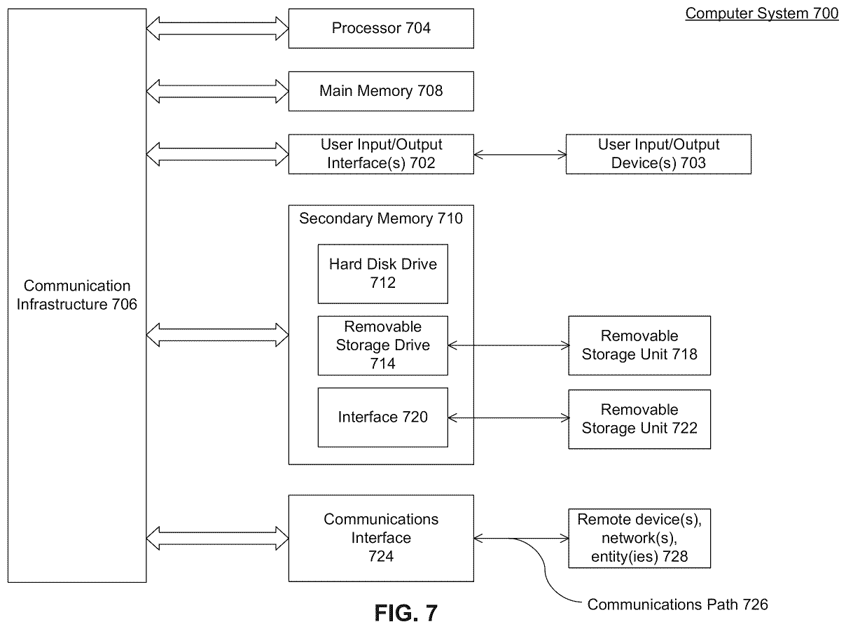

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof. For example, one or more computer systems 700 may be used to implement dispatch system 110, batch control system 112, batch control system database(s) 114, GPS truck tracking system 116, performance monitoring client 302, performance monitoring backend 306, performance monitoring dashboard 308, processor 424, processor 426, or turn head controller 612.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of removable storage unit 722 and interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### G. Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or variable, but every embodiment can not necessarily include the particular feature, structure, or variable. Moreover, such phrases are not necessarily referring to the same embodiment. Further, when a particular feature, structure, or variable is described in connection with an embodiment, it would be within the knowledge of persons skilled in the relevant art(s) to incorporate such feature, structure, or variable into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other. The breadth and scope of this disclosure should not be limited by any of the above-described exemplary embodiments, but should be defined only in accordance with the following claims and their equivalents.

What is claimed is:

1. A computer-implemented method, comprising:
detecting that a hopper coupled to a truck is under a truck loading point of a concrete plant based on one or more signals provided by one or more sensors;
obtaining an identifier associated with the truck;
determining that the identifier is associated with a ticket that indicates that the truck is scheduled to be loaded at the truck loading point of the concrete plant; and
determining that the truck is ready to be loaded based on (i) detecting that the hopper of the truck is under the truck loading point of the concrete plant (ii) determining that a mixer drum of the truck is rotating at a predetermined speed and a predetermined direction and (iii) determining that the identifier is associated with a truck number on the ticket.

2. The computer-implemented method of claim 1, further comprising:
sending a control signal to a processor communicatively coupled to one or more material batchers located at the truck loading point, wherein the control signal causes one or more gates of the one or more material batchers to open, thereby causing cement and aggregate to dispense into a hopper of the truck.

3. The computer-implemented method of claim 1, further comprising:
sending a control signal to a processor communicatively coupled to the mixer drum of the truck that causes the mixer drum to rotate at another predetermined speed and another predetermined direction.

4. The computer-implemented method of claim 1, further comprising:
determining that the truck is proximate to a slump rack;
determining an amount of time that the truck is to be proximate to the slump rack; and
causing a timer to be displayed via a display in accordance with the amount of time.

5. The computer-implemented method of claim 4, further comprising:
prior to the truck being proximate to the slump rack, sending a first control signal to a processor communicatively coupled to a mixer drum of the truck that causes the mixer drum to rotate at another predetermined speed and another predetermined direction; and
after determining that the truck is proximate to the slump rack, sending a second control signal to the processor that causes the mixer drum to rotate in accordance with a charging mode.

6. The computer-implemented method of claim 1, where obtaining the identifier associated with the truck comprises at least one of:
obtaining the identifier based on a code associated with the truck;
obtaining the identifier from a tag associated with the truck; or
obtaining the identifier based on a wireless signal associated with the truck.

7. The computer-implemented method of claim 1, wherein the one or more sensors comprise:
one or more photoelectric sensors;
one or more photodetector sensors;
one or more inductive sensors;
one or more ultrasonic sensors; or
one or more cameras.

8. A system, comprising:
a memory; and
at least one processor coupled to the memory and configured to:
detect that a hopper coupled to a truck is under a truck loading point of a concrete plant based on one or more signals provided by one or more sensors;
obtain an identifier associated with the truck;
determine that the identifier is associated with a ticket that indicates that the truck is scheduled to be loaded at the truck loading point of the concrete plant; and
determine that the truck is ready to be loaded based on (i) detecting that the hopper of the truck is under the truck loading point of the concrete plant (ii) determining that a mixer drum of the truck is rotating at a predetermined speed and a predetermined direction and (iii) determining that the identifier is associated with a truck number on the ticket.

9. The system of claim 8, wherein the at least one processor is further configured to:
send a control signal to a processor communicatively coupled to one or more material batchers located at the truck loading point, wherein the control signal causes one or more gates of the one or more material batchers to open, thereby causing cement and aggregate to dispense into a hopper of the truck.

10. The system of claim 8, wherein the at least one processor is further configured to:
send a control signal to a processor communicatively coupled to the mixer drum of the truck that causes the mixer drum to rotate at another predetermined speed and another predetermined direction.

11. The system of claim 8, wherein the at least one processor is further configured to:
determine that the truck is proximate to a slump rack;
determine an amount of time that the truck is to be proximate to the slump rack; and
cause a timer to be displayed via a display in accordance with the amount of time.

12. The system of claim 11, wherein the at least one processor is further configured to:
prior to the truck being proximate to the slump rack, send a first control signal to a processor communicatively coupled to a mixer drum of the truck that causes the mixer drum to rotate at another predetermined speed and another predetermined direction; and
after determining that the truck is proximate to the slump rack, send a second control signal to the processor that causes the mixer drum to rotate in accordance with a charging mode.

13. The system of claim 8, where, to obtain the identifier associated with the truck, at least one processor is configured to:
obtain the identifier based on a code associated with the truck;
obtain the identifier from a tag associated with the truck; or
obtain the identifier based on a wireless signal associated with the truck.

14. The system of claim 8, wherein the one or more sensors comprise:
one or more photoelectric sensors;
one or more photodetector sensors;
one or more inductive sensors;
one or more ultrasonic sensors; or
one or more cameras.

15. A non-transitory computer-readable device having instructions stored thereon that, when executed by at least one computing device, cause the at least one computing device to perform operations, the operations comprising:
detecting that a hopper coupled to a truck is under a truck loading point of a concrete plant based on one or more signals provided by one or more sensors;
obtaining an identifier associated with the truck;
determining that the identifier is associated with a ticket that indicates that the truck is scheduled to be loaded at the truck loading point of the concrete plant; and
that the truck is ready to be loaded based on (i) detecting that the hopper of the truck is under the truck loading point of the concrete plant (ii) determining that a mixer drum of the truck is rotating at a predetermined speed and a predetermined direction and (iii) determining that the identifier is associated with a truck number on the ticket.

16. The computer-implemented method of claim 15, further comprising:
sending a control signal to a processor communicatively coupled to one or more material batchers located at the truck loading point, wherein the control signal causes one or more gates of the one or more material batchers to open, thereby causing cement and aggregate to dispense into a hopper of the truck.

17. The computer-implemented method of claim 15, further comprising:
sending a control signal to a processor communicatively coupled to the mixer drum of the truck that causes the mixer drum to rotate at another predetermined speed and another predetermined direction.

18. The computer-implemented method of claim 15, further comprising:
determining that the truck is proximate to a slump rack;
determining an amount of time that the truck is to be proximate to the slump rack; and
causing a timer to be displayed via a display in accordance with the amount of time.

19. The computer-implemented method of claim 18, further comprising:
prior to the truck being proximate to the slump rack, sending a first control signal to a processor communicatively coupled to a mixer drum of the truck that causes the mixer drum to rotate at another predetermined speed and another predetermined direction; and
after determining that the truck is proximate to the slump rack, sending a second control signal to the processor that causes the mixer drum to rotate in accordance with a charging mode.

20. The computer-implemented method of claim 15, where obtaining the identifier associated with the truck comprises at least one of:
obtaining the identifier based on a code associated with the truck;
obtaining the identifier from a tag associated with the truck; or
obtaining the identifier based on a wireless signal associated with the truck.
